(19) United States
(12) Patent Application Publication
(10) Pub. No.: US 2002/0026436 A1
(43) Pub. Date: Feb. 28, 2002

(54) Supplanting application setup data and preserving the application setup data that has been supplanted

(76) Inventor: Rafael Joory, London (GB)

Correspondence Address: W. KARL RENNER, Fish & Richardson P.C., 601 Thirteenth Street, NW, Washington, DC, 20005, US

(21) Appl. No.: 09/943,065

(22) Filed: Aug. 31, 2001

Related U.S. Application Data
(60) Provisional application No. 60/229,041, filed on Aug. 31, 2000.

(51) Int. Cl. G06F 7/00

(52) U.S. Cl. 707/1; 707/104.1

(57) ABSTRACT

The setup data from a source application or computer may be accessed and used to supplant the setup data from a destination application or computer, and the supplanted setup data may be preserved for reinstatement or future access. The supplanting setup data may be stored in a data store that is accessible to the destination, and may be local or remote to either or both of the source and destination. When the setup data is used to supplant data within a destination application, the incumbent setup data from that destination application may be stored in the data store, such that the data store includes first application setup data derived from one or more source software applications and second application setup data obtained based on application setup data that has been supplanted with one or more of the first application setup data.

### CROSS REFERENCE TO RELATED APPLICATIONS

This application claims priority from U.S. Provisional Application No. 60/229,041, filed Aug. 31, 2000, and titled “Roaming Profile,” which is incorporated by reference in its entirety.

### TECHNICAL FIELD

This invention relates to a process and system for supplanting application setup data and preserving the application setup data that has been supplanted.

### BACKGROUND

Computing devices may be designed to enhance personal productivity and provide entertainment or services. To this end, computing devices generally accommodate software applications that include one or more configurable settings used to enhance the utility and/or change the display for users wishing to customize the setup of those software applications.

For instance, Microsoft Outlook is a software package that includes configurable display settings such as a display customization setting for its task lists. Using these settings, a user is given an opportunity to adjust column format, sort order, etc. However, the settings established by a user are generally accessible only to the particular instance of the software application that they modify.

As such, to maintain a consistent user experience when moving from system to system, a user who customizes the setup of an application run by one computer system may find it necessary to redundantly customize the setup of a corresponding application run by a second computer system. This task may be laborious, time consuming, and difficult to perform with accuracy.

Yet, with a work force that is becoming increasingly mobile, it is becoming increasingly important to enable seemless access to multiple computer resources.

### SUMMARY

The setup data from a source application or computer may be accessed and used to supplant the setup data from a destination application or computer, and the supplanted setup data may be preserved for reinstatement or future access. The supplanting setup data may be stored in a data store that is accessible to the destination, and may be local or remote to either or both of the source and destination. When the setup data is used to supplant data within a destination application, the incumbent setup data from that destination application may be stored in the data store, such that the data store includes first application setup data derived from one or more source software applications and second application setup data obtained based on application setup data that has been supplanted with one or more of the first application setup data.

These general and specific aspects may be implemented using a system, a method, or a computer program, or any combination of systems, methods, and computer programs. Other features will be apparent from the description and drawings, and from the claims.

### DESCRIPTION OF DRAWINGS

FIG. 1 is a block diagram illustrating components of a system capable enabling a first application access to the setup data of a second application;

FIG. 2 is a block diagram illustrating a general computer network architecture that may be used to implement aspects of the system of FIG. 1;

FIG. 3 is a block diagram illustrating components of a computer, for instance, within the network architecture illustrated by FIG. 2;

FIG. 4 is a block diagram illustrating contents of a memory or storage device that have been extracted from at least one source application and that are made accessible to one or more destination applications;

FIG. 5A is a block diagram illustrating the interrelationship between components of an exemplary system capable of extracting setup data from a source application;

FIG. 5B is a flowchart illustrating an exemplary process for extracting setup data from a source application using the components illustrated by FIG. 5A;

FIG. 6A is a block diagram illustrating the interrelationship between components of an exemplary system capable of loading setup data from setup storage to a destination application;

FIG. 6B is a flowchart illustrating an exemplary process for supplanting incumbent setup data of a destination application with setup data from a source application the components illustrated by FIG. 6A;

FIG. 7A is a block diagram illustrating the interrelationship between components of an exemplary system capable of restoring the setup data of a destination application that has been supplanted; and

FIG. 7B is a flowchart illustrating an exemplary process for restoring the setup data of a destination application that has been supplanted using the components illustrated by FIG. 7A.

In the figures, like reference symbols may be used to identify like elements.

### DETAILED DESCRIPTION

Setup data from a source software application (“source application”) may be stored and used to subsequently supplant the setup data of a destination software application (“destination application”), generally maintaining the integrity of the setup data being supplanted at the destination application. The source and destination applications may be stored on a single computer system, different computer systems that are capable of communicating with each other, or different computer systems that are unable to communicate with each other but that each are able to communicate with a storage device capable of storing and making accessible the application setup data.

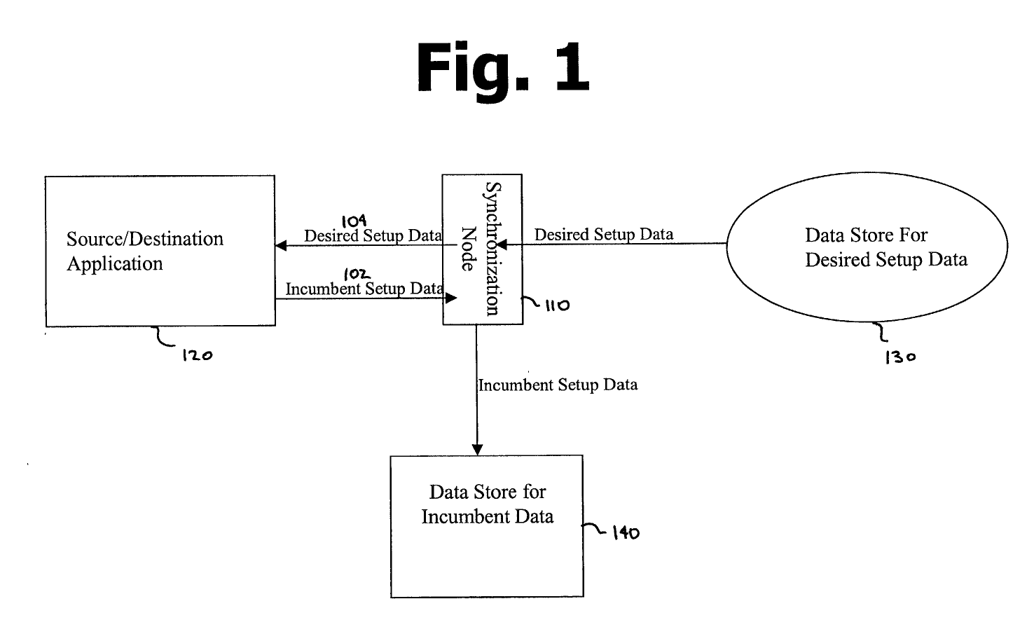

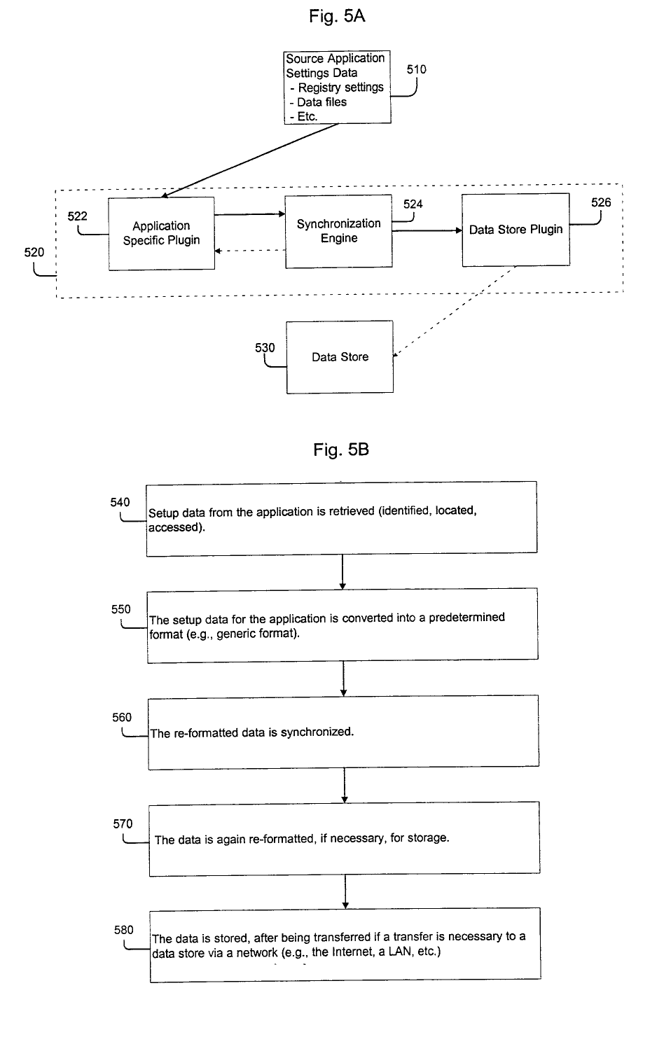

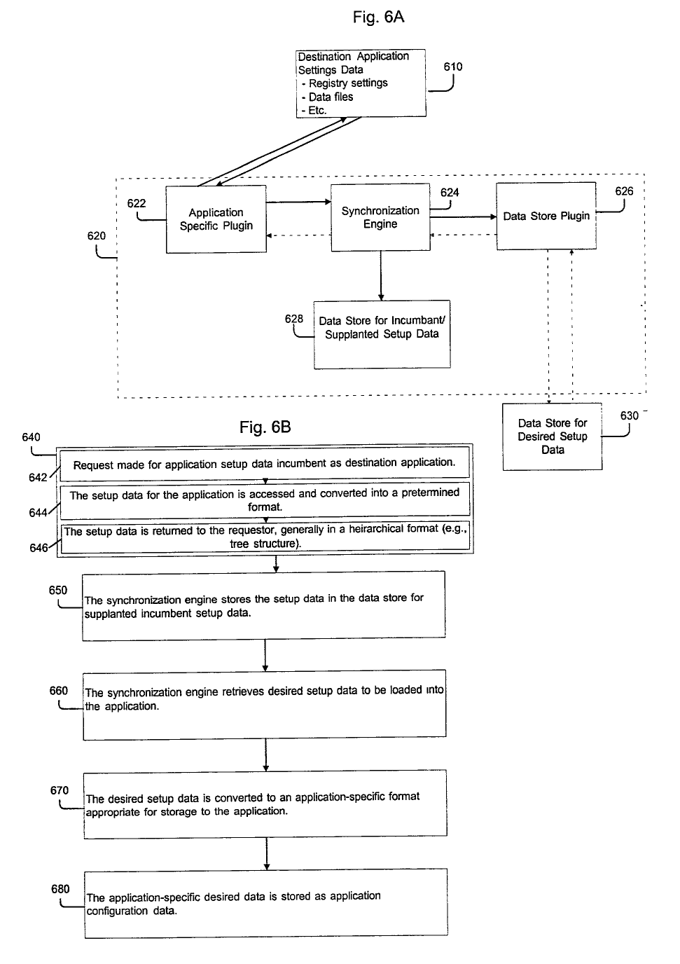

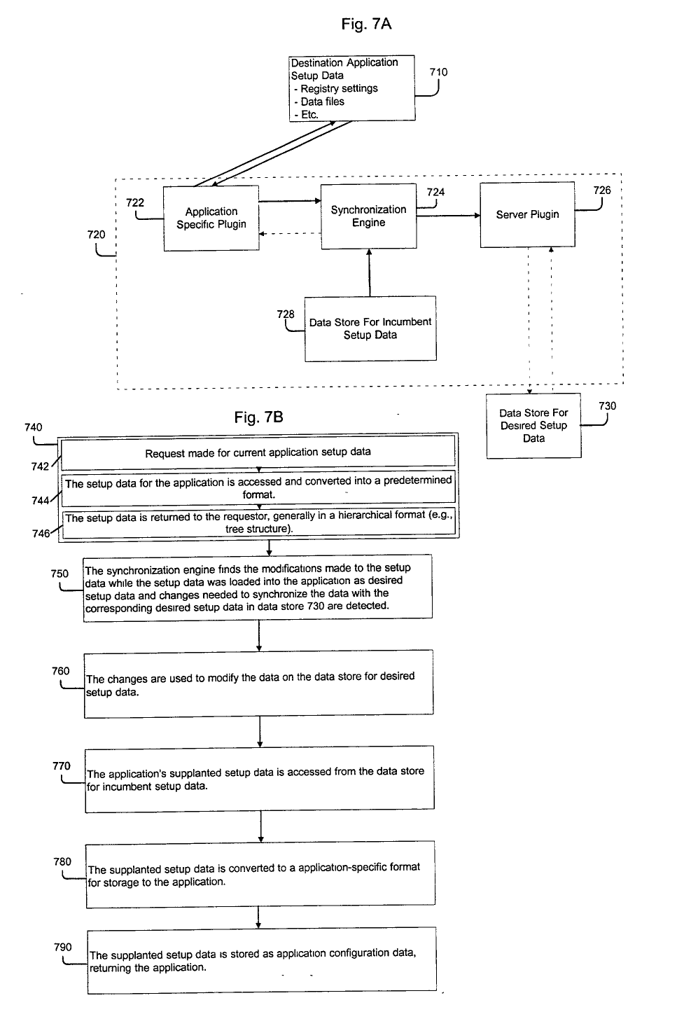

Referring to FIG. 1, a synchronization server 110 coordinates the process of extracting setup data from a source application 120 and storing that data in a setup data store 130 for subsequent access (see FIGS. 5A-5B), supplanting the incumbent setup data 102 of a destination application 120 with desired setup data 104 (see FIGS. 6A-6B), and reinstating to the destination application 120 incumbent setup data 102 that is preserved using data store 140, if appropriate (see FIGS. 7A-7B).

Reference numeral 120 represents either of a source or a destination application, depending upon which of the above-noted operations are being performed by the synchronizer 110. For instance, when the synchronizer 110 coordinates extraction of setup data 102, reference numeral 120 represents a source application. By contrast, when the synchronizer 110 coordinates the processes of supplanting (solid lines) and reinstating (broken lines), reference numeral 120 represents a destination application.

Source and destination applications 120 generally are customized with user preferences and configuration changes. The source and destination applications may be different instances of the same application (e.g., two different instances of Microsoft Outlook), different applications of similar type (e.g., the destination application is Microsoft Outlook and the source application is Eudora, both being mail applications), or different applications of different type that each are capable of being customized based on at least one common setup data (e.g., Microsoft Excel and Microsoft Word that each may be customized based on various common setup data such as formatting menu setup data). Examples of source and destination applications include e-mail applications, office productivity and organizer applications (e.g., address book applications, task-tracking applications, and calendar applications), Instant Messaging (IM) applications, dial-up and other networking applications, desktop applications, computer games, server-based applications (e.g., web servers, database servers, exchange servers, and Lotus Notes servers), and operating systems for both desktops and servers (e.g., DOS, Windows™, Windows 95™, Windows 98™, Windows 2000™, Windows NT™, OS/2, and Linux). Either or both of the source and destination applications may be configured to access only local setup data or they may be configured to access remotely-stored setup data. Furthermore, either or both of the source and destination applications, or the operating systems on which they run, may be capable of supporting and may be configured to support only one identity, or they may be capable of supporting and configured to support more than one identity.

Setup data store 130 and temporary data store 140 may be implemented using independent or shared hardware resources (e.g., hard drive, flash memory, portable memory or storage). The hardware resources used to implement either or both of data stores 130 and 140 may also be used to store one or more of the source and destination applications, or they may be independent of the memory resources used to store those applications.

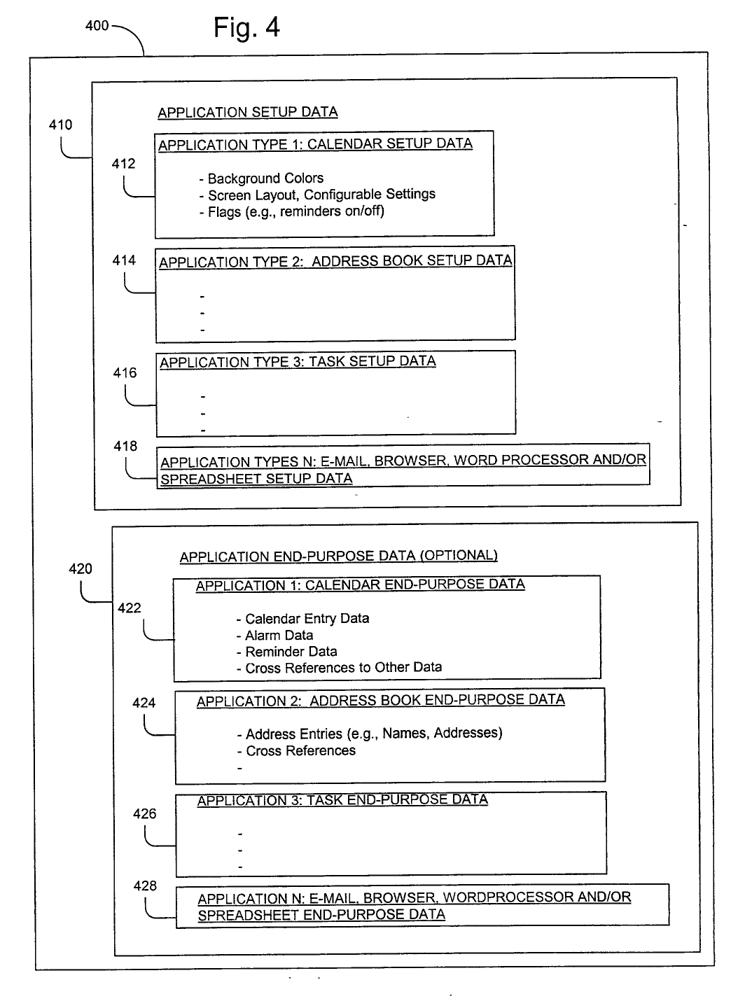

The contents of at least the setup data store 130 include setup data that has been customized for at least one application. The contents of data store 140 are similar, if not identical, in form and type to those of data store 130. However, unlike the setup data in data store 130 that is maintained to supplant the setup data of destination applications, the setup data of data store 140 corresponds to setup data from the one or more destination applications supplanted by data from within data store 140 during the period in which that data is supplanted. Therefore, the contents of data store 140 may be contrasted with the contents of data store 130 in that they tend to be fewer in number and they tend to be stored for shorter periods of time. A more detail description of content types stored in the data stores 130 and 140 are provided later with respect to FIG. 4.

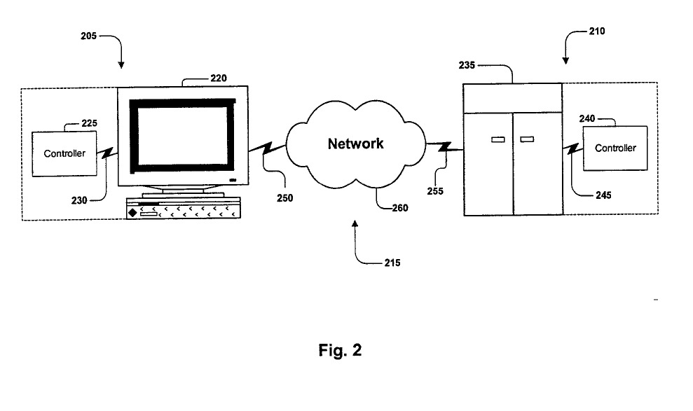

As indicated, two or more of the source application, the destination application, and the setup data storage may be stored on different computer systems in a network that enables communications among the different computer systems. Referring to FIG. 2, a network configuration may be established to enable communications therebetween. Specifically, in one implementation of such a network, the first (e.g., client) system 105 typically includes one or more devices 120 and/or controllers 125, and the second (e.g., host) system 110 typically includes one or more devices 135 and/or controllers 140. For example, the first system 105 or the second system 110 may include one or more general-purpose computers (e.g., personal computers), one or more special-purpose computers (e.g., devices specifically programmed to communicate with each other and/or the first system 105 or the second system 110), or a combination of one or more general-purpose computers and one or more special-purpose computers. The first system 105 and the second system 110 may be arranged to operate within or in concert with one or more other systems, such as, for example, one or more LANs (“Local Area Networks”) and/or one or more WANs (“Wide Area Networks”).

The device 120 (or the controller 135) is generally capable of executing instructions under the command of a controller 125 (or a controller 140). The device 120 (or the device 135) is connected to the controller 125 (or the controller 140) by a wired or wireless data pathway 130 or 145 capable of delivering data.

The device 120, the controller 125, the device 135, and the controller 140 each typically include one or more hardware components and/or software components. An example of a device 120 or a device 135 is a general-purpose computer (e.g., a personal computer) capable of responding to and executing instructions in a defined manner. Other examples include a special-purpose computer, a workstation, a server, a device, a component, other physical or virtual equipment or some combination thereof capable of responding to and executing instructions.

An example of first controller 125 or a second controller 140 is a software application loaded on the device 120 or the device 135 for commanding and directing communications enabled by the device 120 or the device 135. Other examples include a program, a piece of code, an instruction, a device, a computer, a computer system, or a combination thereof, for independently or collectively instructing the device 120 or the device 135 to interact and operate as described. The controller 125 and the controller 140 may be embodied permanently or temporarily in any type of machine, component, physical or virtual equipment, storage medium, or propagated signal capable of providing instructions to the device 120 or the device 135.

The communications link 115 typically includes a delivery network 160 making a direct or indirect communication between the first system 105 and the second system 110, irrespective of physical separation. Examples of a delivery network 160 include the Internet, the World Wide Web, WANs, LANs, analog or digital wired and wireless telephone networks (e.g. PSTN, ISDN, and xDSL), radio, television, cable, satellite, and/or any other delivery mechanism for carrying data. The communications link 115 may include communication pathways 150, 155 that enable communications through the one or more delivery networks 160 described above. Each of the communication pathways 150, 155 may include, for example, a wired, wireless, cable or satellite communication pathway.

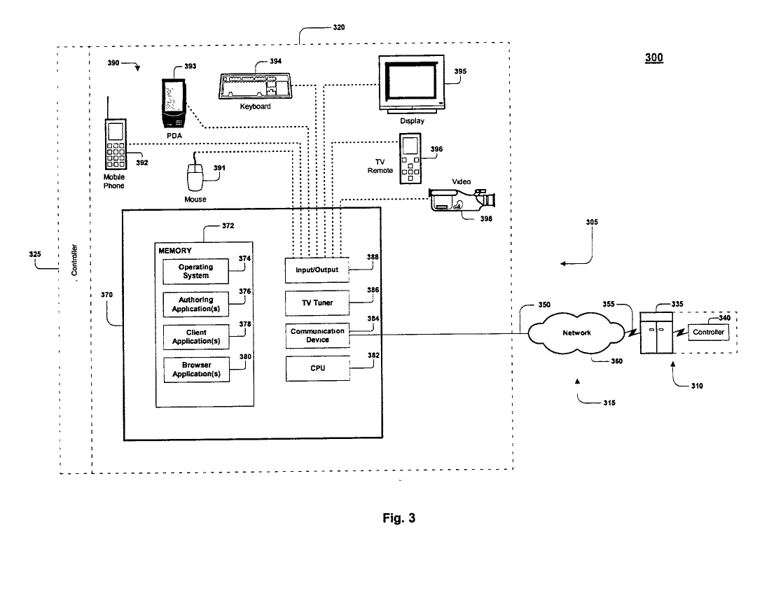

Referring to FIG. 3, the computer system used to store the source application 120, the destination application 120, and the systems enabling access to the data stores 130 and 140 may include various hardware components. For instance, FIG. 3 illustrates a communications system 300 including a first system 305 communicating with a second system 310 through a communications link 315. First system 305 typically includes one or more first devices 320 and one or more first controllers 325 for controlling the first devices 320. Second system 310 typically includes one or more second devices 335 and one or more second controllers 340 for controlling the second devices 335. The communications link 315 may include communication pathways 350, 355 enabling communications through the one or more delivery networks 360.

Examples of each element within the communication system of FIG. 3 are broadly described above with respect to FIG. 2. In particular, the second system 310 and the communications link 315 typically have attributes comparable to those described with respect to the second system 210 and the communications link 215 of FIG. 2, respectively. Likewise, the first system 305 of FIG. 3 typically has attributes comparable to and may illustrate one possible implementation of the first system 205 of FIG. 2.

The first device 320 typically includes a general purpose computer 370 having an internal or external storage 372 for storing data and programs such as an operating system 374 (e.g., DOS, Windows™, Windows 95™, Windows 98™, Windows 2000™, Windows NT™, OS/2, and Linux) and one or more application programs. Examples of application programs include authoring applications 376 (e.g., word processing, database programs, spreadsheet programs, and graphics programs) capable of generating documents or other electronic content; first applications 378 (e.g., AOL client, CompuServe client, AIM client, AOL TV client, and ISP client) capable of communicating with other computer users, accessing various computer resources, and viewing, creating, or otherwise manipulating electronic content; and browser applications 380 (e.g., Netscape's Navigator and Microsoft's Internet Explorer) capable of rendering standard Internet content.

The general-purpose computer 370 also includes a central processing unit 382 (CPU) for executing instructions in response to commands from the first controller 325. In one implementation, the first controller 325 includes one or more of the application programs installed on the internal or external storage 372 of the general-purpose computer 370. In another implementation, the first controller 325 includes application programs externally stored in and executed by one or more device(s) external to the general-purpose computer 370.

The general-purpose computer typically will include a communication device 384 for sending and receiving data. One example of the communication device 384 is a modem. Other examples include a transceiver, a set-top box, a communication card, a satellite dish, an antenna, or another network adapter capable of transmitting and receiving data over the communications link 315 through a wired or wireless data pathway 350. The general-purpose computer 370 also may include a TV (“television”) tuner 386 for receiving television programming in the form of broadcast, satellite, and/or cable TV signals. As a result, the first device 320 can selectively and/or simultaneously display network content received by communications device 384 and television programming content received by the TV tuner 386.

The general-purpose computer 370 typically will include an input/output interface 388 to enable a wired or wireless connection to various peripheral devices 390. Examples of peripheral devices 390 include, but are not limited to, a mouse 391, a mobile phone 392, a personal digital assistant 393 (PDA), a keyboard 394, a display monitor 395 with or without a touch screen input, and/or a TV remote control 396 for receiving information from and rendering information to subscribers. Other examples may include voice recognition and synthesis devices.

Although FIG. 3 illustrates devices such as a mobile telephone 392, a PDA 393, and a TV remote control 396 as being peripheral with respect to the general-purpose computer 370, in another implementation, such devices may themselves include the functionality of the general-purpose computer 370 and operate as the first device 320. For example, the mobile phone 392 or the PDA 393 may include computing and networking capabilities, and may function as a first device 320 by accessing the delivery network 360 and communicating with the second system 310. Furthermore, the first system 305 may include one, some or all of the components and devices described above.

FIG. 4 illustrates data that may be accessed by, extracted from, or made accessible to source and destination systems 120. For instance, referring to FIG. 4, either or both of data stores 130 and 140 may include a data structure 400 for accommodating setup data 410 that has been extracted or otherwise derived from various applications or application types, or attained through direct input, e.g., into a database interface.

Within data structure 400, application setup data 410 may be arranged according to application type. The number of application types generally is not constrained, other than by memory/storage space, nor is the number of sub-categories within an application type. Examples of application setup data types shown by FIG. 4 include calendar setup data 412, address book setup data 414, task setup data 416, among others 418 (e.g., e-mail setup data, browser setup data, and spreadsheet and word processor setup data).

Within one or more setup data types, various setup data sub-types may be stored. For instance, for a calendar application type, application setup data 412 may include sub-types such as background color setup data and screen layout setup data. Setup data types also may include default settings which may or may not be customizable. For example, with respect to reminders, calendar setup data 412 may include a default setting indicating whether or not to invoke reminder flags, a default setting to indicate the amount of time prior to a calendar event that reminders typically will be presented to a user, a default setting to indicate the starting day of the week (i.e. Sunday or Monday), and a default setting to indicate the start and stop hours of a default work day. Similarly, address book setup data 414 may include address book viewing options (e.g., settings to indicate whether the default address book view shows all or some limited data associated with each particular address book entry), and sort order criteria used to indicate how the particular address book entries are sorted (e.g., by last name, first name, or company affiliation). Task type application setup data 416 may include specific column headings, whether completed tasks are displayed, and the color used to represent overdue tasks.

As shown, the data structure 400 also may include end-purpose data 420 for one or more applications or application types, although this data is optional. Like application setup data 410, application end-purpose data 420 also can be organized based on application type. For example, in the illustrated implementation, the structure of the application end-purpose data 420 mirrors the structure of the application setup data 410. That is, application types used to organize application setup data 410 also may be used to organize application end-purpose data 420. Examples of application end-purpose data types include calendar end-purpose data 422, address book end-purpose data 424, task end-purpose data 426, among others 428 (e.g., e-mail, browser, word processor and spreadsheet end-purpose data).

Within each end-purpose data type, various data types may be stored. For example, application end-purpose data 420 for a calendar 422 may include calendar entry data, alarm data, reminder data, and cross references to other application end-purpose data such as related contact entries. Similarly, within an address book type 424, application end-purpose data 420 may include address entries (e.g., individual name data, address data, company affiliation data, phone number data, e-mail data and web address data) and cross-references to other related application end-purpose data 420 (e.g., related contact entries). Within a task application type 426, application end-purpose data 420 may include task entry-specific data (e.g., title data, due date data, assigned personnel data) and cross references to other application end-purpose data 420, such as address book and calendar application end-purpose data 424 and 422.

Furthermore, similar to the setup data described above, application end-purpose data 420 within one or more of the application types may be organized by attributes common to that application type. For example, a web browser application type may include a list of cookies received after visiting those web sites. And, where feasible, these data types may be organized into smaller groups still. For example, the cookies received from favorite web sites might be further organized by their fully qualified Internet domain names.

Several examples of application setup data 410 and application end-purpose data 420 are provided above with respect to the particular application types shown in the data structure 400 illustrated by FIG. 4 (e.g., calendar, address book, task). These examples begin to illustrate differences between the two data types 410 and 420. To further distinguish application setup data and application end-purpose data, it is helpful to compare and contrast more general characteristics of each data type and to consider several additional examples of each. As such, a more general description of each type of data and the distinctions among them is provided below, including and followed by additional examples of each.

Application end-purpose data tends to reflect data being stored, organized or operated on by the application. Application end-purpose data may be created, modified, stored and/or processed as the ostensible end-purpose of the application. For example, application end-purpose may data include the contents of a calendar appointment in a calendar application designed to track such appointments, the data in an e-mail message in an e-mail application designed to handle such messages, or the contact data for a specific entity in an address book application designed to store contact data. The application end-purpose data tends to change relatively frequently while data in an application accumulates (e.g., mail archive or address book entries) or evolves (e.g., calendar entries).

By contrast, application setup data generally is used to personalize an application according to default or user-customized setup criteria. Many users personalize their application setup criteria only once, generally at installation or first use, infrequently modifying setup criteria at a later date. Application setup data therefore tends to change infrequently, if at all, once established with respect to an identity.

In view of these characteristics, it is sometimes possible to identify and distinguish application end-purpose data and application setup data based on their frequency of update/storage. For instance, with respect to the “favorites” menu in the Internet Explorer software application, the following data items are ranked based on frequency of update (with the highest frequency first) and labeled as either of application end-purpose data or application setup data: (i) a list of the favorites themselves (application end-purpose data), a list of folders entered by the user in organizing their favorites (application end-purpose data), the order in which favorites appear in folders (application setup data), the order in which the folders are arranged (the folder structure) (application setup data), and other visual setup data (e.g., toolbar composition, window size, window composition options or preferences)(application setup data).

With respect to the Microsoft Outlook software application, application end-purpose data generally is located in personal folders files (.pst), offline storage folders files (.ost) and exchange server data files. Additional examples of application end-purpose data include the data populating a spreadsheet, the data forming the content within a word processing document, data related to the names of folders such as mail folders and contacts folders, calendar entries and data-specific attributes of calendar entries, contact entries and data-specific attributes of a contact entries (e.g., name, address, telephone, e-mail), mail messages and data-specific attributes of mail messages, journal entries and data-specific attributes of journal entries, and notes and task entries and data-specific attributes of notes and task entries.

Conversely, application setup data typically is related to information service settings, visual configuration settings, and tool settings. More specifically, application setup data typically include configuration settings for the menu display, e.g., of a spreadsheet or word processing application, as well as other settings such as the automatic tab settings in a word processing document, folders options in Windows Explorer, or settings in the Control Panel of Windows. In Microsoft Outlook, application setup data within information service settings may include attributes specified using menus within the Microsoft Exchange Server and Internet E-mail tools, including (i) server name, (ii) mailbox, (iii) password, (iv) “when starting” settings, (v) additional mailboxes, (vi) “encrypt information” settings, (vii) logon network security, (viii) offline folder file settings, (ix) mail account name, (x) user name, (xi) organization, (xii) e-mail address, (xiii) reply address, (xiv) incoming mail server, (xv) outgoing mail server, (xvi) account name, (xvii) password, and (xviii) outgoing mail server settings—(account name, password, etc.). Other application setup data within the information service settings (e.g., the Outlook Address book, the personal address book, and the personal folders file) may be accessed using the lightweight directory assistance format (LDAP), or may be specified using the delivery location tab or the addressing tab. Application setup data within the visual application setup data may include attributes such as window size, selected shortcuts and attributes selected using a “view” menu, for example, (i) current view, (ii) “customize current view” settings, (iii) “define view” settings, (iv) “format columns” settings, (v) outlook bar, (vi) folder list, (vii) toolbar settings, (viii) custom toolbars, (ix) status bar, and (x) preview pane. Application setup data configured using the tool menu may include: (i) message rules, (ii) macros, (iii) options and settings in tabs or buttons that have options, (iv) customize button settings, (v) organize button settings, and (vi) junk senders lists and settings. In addition, the Outlook Profile generally contains application setup data with respect to at least the service specifications. Application setup data may also include information pertaining to the structure and organization of folders such as mail and contact folders.

As demonstrated above, different types of application setup data may impact multiple configuration settings, in one or more applications or application types. For example, application setup data for the type and content of toolbars to be displayed may be used to control defaults within a single application, and application setup data for the default color for window background may be used to control defaults within more than one application. Conversely, the applicability of one or more application setup data may be limited to a single application or some aspect of a particular application. For instance, display criteria useful in establishing a default view for a particular calendar entry may not have applicability to the default display setting for e-mail messages.

To the extent that data may be characterized as both of application end-purpose data and application setup data, it shall be characterized as application end-purpose data for purposes of this application.

Data structure 400 may be embodied within a single file or it may be a logical representation of data from within several different files. The data structure 400, or fields of the data structure 400, may be physically stored local to the source application from which they were derived and the destination application to which they are made accessible, or they may be stored remote from one or both of the source and destination applications. For instance, the application setup data 410 may be stored local to the source application if accessible to the destination application from this position. Similarly, the application setup data 410 may be stored local to the destination application, particularly if accessible to other destination applications from this location. And, the application setup data 410 maybe stored remote from the source and destination applications, provided that the application setup data 410 remains accessible to the source and destination applications.

Furthermore, the application setup data 410 may be stored with or separate from application end-purpose data 420. For instance, the same storage may be dedicated to storing the application setup data 410 and application end-purpose data 420. However, the application setup data 410 and application end-purpose data 420 may be stored in physically distinct locations, or the application setup data 410 may be handled without handling the application end-purpose data 420.

The format of data within the data structure 400 generally is consistent for similar applications or application types, but may vary. For instance, the setup data stored with respect to calendar applications 412 includes several fields that may be formatted similarly according to a calendar-specific format (e.g., a Microsoft Outlook specific format). However, the format of the calendar field entries may differ from the format of setup data stored with respect to e-mail applications 414, which may be formatted according to an e-mail specific format (e.g., a Eudora specific format). Conversely, as will be demonstrated through the exemplary implementations of FIGS. 5A-7B, data within one or more portions of the data structure 400 may be stored with a format that is generic to more than one application, or unique to all applications accessing the data structure 400.

Data within the data structure 400 may be organized in a hierarchical style (e.g., using a tree structure) or otherwise.

The format of stored setup data may be generic or it may comport with an application-specific format. For instance, it is possible for the setup data to be stored according to the format of the source application from which it is derived, according to the format of a different application (e.g., perhaps the destination application), or generically according to a format that differs from formats specified by either or both of the source and destination application formats (e.g., an application generic format).

Data within the data structure 400 may be grouped by application or application type, as described above. Therefore, within the data structure 400, a common data structure may be used to represent all data of similar type, enabling operations to be performed on that data regardless of the whether the data is stored in association with a particular application or application type, derived from the same or a different source, etc.

As will be described with respect to FIGS. 5A-7B, the organization of the data within data structure 400 and the use of these interfaces may be useful in synchronizing and writing data intelligently.

FIGS. 5A-5B, 6A-6B, and 7A-7B illustrate examples of hardware and software capable of gathering and storing application setup data, supplanting incumbent setup data with stored setup data, and restoring incumbent setup data, respectively.

More specifically, the processes of FIGS. 5B, 6B and 7B are described generally as follows. At least the application settings data of a source application are identified, accessed and stored in an accessible storage medium. See FIGS. 5A-5B. If/when it becomes necessary or desirable to load stored setup data for use by a destination application, the incumbent setup data of the destination application is saved in a dormant state and then supplanted by the desired setup data from the storage medium. See FIGS. 6A-6B. Then, if/when the user no longer requires access to the destination application or seeks to return the application to the now-dormant incumbent setup data, the version of the supplanting data stored by the storage medium is updated to reflect changes thereto, and the incumbent setup data is reinstated at the destination application. See FIGS. 7A-7B.

More specifically, referring to FIG. 5A, system 500A may be used to identify and store the setup data of an application to an accessible data store. The system 500A includes three segments—a source application and interface (GUI) 510, a synchronization core 520, and a data store 530. These segments may include various components and may be implemented using devices structured and arranged as described with respect to FIGS. 1-3, or otherwise.

The source application 510 allows user interaction and provides a source of application setup data for storage within data store 530. The source application 510 may include any of the application types mentioned previously with respect, for example, to FIG. 4.

The synchronization core 520 manages communications with source application 510 and data store 530. The synchronization core 520 includes application-specific plug-in 522, synchronization engine 524, and data store plug-in 526.

Application-specific plug-in 522 provides a layer between a supported (e.g., source or destination) application 510 and the synchronization engine 524. Among other things, a plug-in 522 identifies setup data accessed by a corresponding source application, locates and accesses setup data to be supplanted from the source application (e.g., using the Windows Registry or by searching the memory or storage of the application-performing machine), and translates setup data communicated back and forth between the supported application and the synchronization engine 524 (e.g., converting the data from an application-specific format to a generic format when extracting the data from the source application or when saving incumbent data that will be supplanted, and from a generic format to an application-specific format when replacing supplanted data with saved data and when reinstating supplanted data). The plug-ins 522 may be stored local to the supported application or the application performing machine, or they may be stored remote to that application or machine if able to access setup and other parameters of the application for which it 522 is designed. As such, the functionality of a plug-in 522 also may be achieved using a remote application having access to the resources of the local machine. Each application-specific plug-in 522 typically corresponds to a particular application, but may correspond to more than one application if the applications access and store data in consistent locations and formats.

Synchronization engine 524 is capable of synchronizing application setup data within data store 530 with corresponding application setup data that has been loaded into a destination application 510, either of which may be changed during the pendency of the application setup data at the destination application. In general, synchronization engine 524 is structured and arranged to enable comparison of at least two logical structures of application setup data (e.g., comparing hash values generated for corresponding fields within logical structures representing the data of the data store 130 and the destination application 110).

Data store plug-in 526 provides a layer between the synchronization engine 524 and the data store 530. Plug-in 526 stores data extracted from a source application into data store 530, identifies that setup data corresponding to destination applications from within data store 530 when seeking to supplant their data, accesses that setup data, and translates setup data communicated between the synchronization engine 524 and the data store 530, when necessary. For example, data communicated by synchronization engine 524 in a generic format may be translated into a storable format to enable storage of setup data extracted from the source application, from a storable format to a generic format when accessing incumbent setup data to be reinstated or desired setup to be used for supplanting incumbent setup data. Like application-specific plug-in 522, plug-in 526 may be stored local to the supported application or the application performing machine, or it may be stored remote to that application or machine if able to access the data store 530. Furthermore, the application-specific plug-ins 526 and 530, although logically distinct, may form a single logical entity or they may differ altogether.

Data store 530 may be local to the supported application or the application performing machine, but alternatively may be remote to that application or machine. For instance, the data store 530 may be distinct from the machine storing and executing the supported application from which setup data is mined. For instance, it generally includes at least one of a server, a hard drive and other devices where extracted setup data is stored for subsequent supplanting. Data store 530 may be accessible via the Internet (e.g., an application configuration access format (ACAP) server, a directory Service such as a lightweight directory access protocol (LDAP), an Active Directory, or a Novell directory service (NDS), an internal message access protocol (IMAP), a hypertext transfer protocol (HTTP), a file transfer protocol (FTP), or some other database), it may be accessible over a somewhat less expansive network (e.g., a LAN or WAN), or it may offer very limited access (e.g., a local file stored on the local computer running the application). The data store 530 tends to grow when new types of application setup data are added because new sections are added to accommodate this data. By contrast, when previously stored application setup data is extracted, the amount of space occupied within the storage system may or may not increase, but the storage system itself does not typically grow.

Referring to FIG. 5B, a process 500B is illustrated for identifying and extracting setup data from a source application 510. The process 500B may include retrieving (e.g., identifying, locating and accessing) (step 540) setup data from an application and converting (step 550) the format of that data, communicating (step 560) the converted data to an engine for synchronization against data previously collected, converting (step 570) the data into a format suitable for future access, and storing (step 580) the data to enable future access.

Specifically, data retrieval (step 540) is application-specific and therefore is accomplished through techniques that may differ from application-to-application. For example, an application that is based on a Microsoft operating system may store a directory of their data in the operating system registry such that registry functions can be used to locate and retrieve that data, while other applications may not store directory information such that file search and input/output (I/O) logic may be used to locate and retrieve their data. Source applications that are candidates for data extraction may be identified overtly based on user input (e.g., user identification of one or more applications for which remote access is likely), through approximation based on user profile information (e.g., information collected including user demographics and usage patterns), or otherwise. Information used to identify source applications may be collected by the synchronization engine 524 such that a request for setup data particular to that application may be sent to an application-specific plug-in 522 corresponding to the identified source application. The application-specific plug-in 522 identifies the setup data for the application, locates that setup data (e.g., using Windows registry functions and/or search functions), and accesses/retrieves that setup data.

Moreover, once a source application is identified, a plug-in 522 corresponding to the identified source application determines configuration setup data available for the application, locates the application setup data using appropriate techniques, and uses the location information to access/retrieve that data (step 540). When a Windows based application is identified as the source, the application setup data may sometimes be located using the Windows Registry. Specifically, for Windows based applications, the HKEY_CURRENT_USER section of the Windows Registry is ordinarily mapped upon log-in to the settings associated with the current user, and therefore may be inspected to reveal the location of application setup data for the application. By contrast, when an application (e.g., a non-Windows based application) is identified that does not store information relating to the application setup data in the Windows Registry, the plug-in 522 for that application may be designed to include search functions for locating the configuration settings data and file I/O operations to access and ultimately supplant the application setup data.

After the application setup data is received from an application (step 550), the plug-in 522 converts the setup data from the application-specific format to a predetermined format (step 560). The predetermined format may be the same as the application-specific format in which case no conversion is necessary. In addition, the predetermined format may be specific to an application to which the data will be applied in the future. However, typically, the predetermined format is generic of application-specific codes such that the data is genericized by the plug-in, with the plug-in stripping the data of application-specific format data. The particular process used for conversion of an application-specific format into a generic format may vary from application-to-application, and therefore is generally built into and handled by the logic of the application-specific plug-ins. The settings data may be loosely structured by strongly typed to allow the synchronization engine to synchronize the settings data with a low level of understanding for the structure (which may be defined by the plug-in). Furthermore, the type of information may be embedded in the data structure 400 that is passed from the plugin to the synchronization engine.

In step 560, the reformatted setup data may be synchronized with previously-stored setup data of similar type, if necessary, by the synchronization engine 524. Using the hierarchical structure described with respect to the data structure 400, synchronization may be performed based on all or a portion of all of the retrieved setup data, e.g., by identifying portions of the data structure corresponding to the retrieved data types and performing comparisons of metrics (e.g., checksums) measured based on the retrieved data and comparable stored setup data.

In step 570, setup data is converted, if necessary, for storage and subsequent access.

In step 580, the setup data is stored in data store 530. Generally, the data store 130 is physically remote from the synchronization engine 524, such that the setup data is communicated to the data store 130 incident to storage therein.

Furthermore, application end-purpose data may be extracted and stored with the application setup data from an application. This process too may be initiated by a request from a synchronization engine to an appropriate application-specific plug-in, with other processes being similar to that performed with respect to the application setup data.

FIGS. 6A and 6B illustrate an exemplary device 600A and process 600B capable of loading application setup data from a data store to a destination application, while preserving the incumbent setup data of the destination application by saving that existing setup data as dormant application setup data.

Referring to FIG. 6A, the components of system 600A share similar characteristics with the counterpart components of FIG. 5A; however, the flow of data communicated between the components differ, as shown by reference arrows, due to the different processes being performed by those components. Furthermore, in FIG. 6A, data store 628 is shown as an additional component of synchronization core 620. Data store 628 stores data displaced from destination application 610. Although logically distinct from data store 630, data store 628 may be configured to store data in similar structures (e.g., data structure 400), and may be implemented using like or same hardware devices.

Referring to FIG. 6B, application setup data and/or application end-purpose data may be transferred from a centralized data store to an application. Similar to the process 500B described in FIG. 5B, this process 600B may be initiated by a request from a synchronization engine (step 640). Specifically, in response to a user request for customization (e.g., user login), a synchronization engine 624 makes a request to an application-specific plug-in 622 to retrieve at least the setup data from the destination application 610 (step 642). Data retrieval is application-specific and may be accomplished using techniques that differ from application-to-application; hence, the use of an appropriate application-specific plug-in 622. After the data is received from the destination application 610, the application-specific plug-in 622 converts the received data from the application-specific format to a generic format (step 644), as described for example with respect to step 550. In one implementation, the generically formatted data is returned to the synchronization engine 624 as a tree (step 646). In any event, the synchronization engine 624 then stores the setup data in a temporary state store 628 (step 650), preserving its integrity in anticipation of future reinstatement of that data.

The synchronization engine 624 uses the data store plug-in 626 to request, from the centralized data store 630, data (e.g., application setup data and/or application end purpose data) that is appropriate for configuring the destination application 610. As such, plug-in 626 receives a data request from synchronization engine 624, identifies data types from within the data store 630 that may be used to satisfy the request and retrieves data within the data store 630 corresponding to the identified data types (step 660).

Plug-in 626 then performs any necessary conversion (step 670) on that retrieved data and returns the data to the synchronization engine 624 for further processing. In one implementation, an ACAP server is used as the centralized data store 630 and an ACAP server plug-in is used as the server plug-in 626. In that implementation, the ACAP server plug-in 626 converts data stored in ACAP format to a generic format when returning the data to the synchronization engine 624. However, rather than saving the data in and therefore translating with respect to an ACAP format, other server types and formats may be utilized, or a generic format may be utilized to avoid the need for the reformatting performed in step 670 (and step 570 of FIG. 5).

The application setup data retrieved from the centralized data store 630 then is transferred by the synchronization engine 624 to an appropriate application-specific plug-in 622 for conversion and storage to the destination application 610. Specifically, the application-specific plug-in 622 may include software that is capable of converting one or more types of data (e.g., background color for mail) having a generic format into an application-specific format appropriate for the destination application 610, identifying an appropriate location for storage of that converted data to enable access by the destination application 610 (e.g., determined by the Windows Registry or through a search of the local machine for the application data files), and storing the converted data to the identified location at the destination application.

A hash of the data downloaded from the server may be generated and downloaded with the data, and used to confirm receipt of all data. This same hash may be used at a later time (e.g., step 750) to identify changes to the data at the local system, and at the server.

At this point, the application setup data and/or the application end-purpose data are written to the destination application (step 680). As previously described, this process is application-specific and may require registry modifications, data file editing, and general file I/O operations. The application-specific plug-in 622 generally is responsible for converting the application setup data and/or application end-purpose data from the generic format returned by the synchronization engine to the application-specific format that is required by the application.

In addition, incident to steps 650-680, a setup process may be performed to prepare the application to receive the new setup data. Specifically, before storing the new data, it may be necessary and/or desirable to delete or otherwise render inaccessible the data from the destination application that is being supplanted, thus avoiding confusion of old and new data may be sufficient to enable receipt of new setup data (e.g., Outlook Express 4.0, Internet Explorer and Palm Pilot Operating System), or it may be necessary to perform other procedures depending upon the specific destination application in question. For instance, in Outlook Express 5.0, it may be necessary or desirable to create a new identity for the new setup data.

Furthermore, when copying end-purpose data into destination applications, it may be necessary or desirable to create an addition to the logical data structure 400 (e.g., a temporary directory on the file system) and to copy or move the incumbent end-purpose data to that temporary directory for future access. And, when moving the incumbent end-purpose data to the temporary directory, it may be useful to limit access to that data while the new setup data is invoked.

For instance, when performing a setup process for a mail application, an application-specific plug-in may create a temporary directory at the local machine or the server, store the contents of the directory corresponding to the mail application “inbox” into the temporary directory, and delete the contents of the directory corresponding to the mail application inbox. Access to the temporary directory may be limited to preserve privacy and/or security. In this example, the directory corresponding to the mail application inbox may be simply renamed to accomplish the renaming and storing steps. However, the setup process then may require creation of a new directory that will function as the mail application inbox for the new identity operating under the supplanting setup data.

Similarly, when reverting to the dormant incumbent setup data (steps 760-790), it may be desirable to store the setup or end-purpose data (e.g., create a temporary directory and store the setup or end-purpose data in a temporary directory) created under the new setup data, and to replace that data with the dormant setup and/or end-purpose data. Where a new directory was created for the dormant setup and/or end-purpose data, the contents of that directory may be copied into the appropriate directory. If the directory was renamed to preserve the supplanting setup or end-purpose data, it may be necessary to create a new directory for the dormant setup or end-purpose data, or to rename directories containing such data appropriately to accomplish the same end. It also may be desirable to remove or limit access to the setup or end-purpose data while the incumbent setup data is invoked. In this manner, the privacy and security may be achieved when different identities use the different setup data.

In any event, the data structure 400 may be changed to reflect the new structure, and the application-specific plug-ins may be designed appropriately to accommodate whichever process is most appropriate.

Referring to FIGS. 7A and 7B, a system 700A and process 700B are illustrated for preserving setup data used to supplant the incumbent setup data of an application, and reinstating dormant setup data that had been previously supplanted from the application. Referring to FIG. 7A, the components of system 700 share similar characteristics with the counterpart components of FIGS. 5A and 6A; however, the flow of data communicated between the components differs, as shown by reference arrows, due to the different process being performed by these components.

Referring to FIG. 7B, the current application setup data and/or application end-purpose data of the destination application is retrieved (step 740). For instance, the synchronization engine 724 may request this information from the application-specific plug-in 722 (step 742). Responsive thereto, the application-specific plug-in 722 determines the available data from within the destination application, and it locates, accesses, retrieves and converts that available data (step 744). Typically, the setup data retrieved from a destination application is converted into a generic format that is returned to the synchronization engine with changes to the hierarchical data structure 400, described previously with respect to FIG. 4 (step 746).

Once in receipt of the data, the synchronization engine compares the current application setup data and the previously-stored application setup data to determine which portions of the data had been modified since the data was loaded into the application from the generic data store (step 750). For instance, changes to data on the local system and at data store 730 may each be detected, including the changes to data on the local system resulting from user operation at that local system and the changes to data at the server resulting from concurrent user operation at different computer systems. A hashing algorithm may be used to produce a fingerprint of data at the time of download. The resulting hash may be downloaded with the data. As described with respect to step 680, the hash may be used to ensure that all data is downloaded to the local system. The same hash also may be used in step 750 to determine whether any changes have been made to the setup data on the local system or the server during use at the local system. Then, depending upon whether the data at the destination application 710 and the data store 730 has changed, synchronization may be modified appropriately to ensure that appropriate application setup data is loaded from the destination application 710 to data store 730.

Thus, changes to different stored instances of the same setup data may be synchronized. By doing so, it is possible to capture changes made to setup data by applications that load that data concurrently from the data store 130, whether the applications are two different instances of a single software application (e.g., two instances of a calendar that are being run concurrently, each having at least one common setup data field loaded from within data store 130) or multiple different software applications (e.g., two different browsers being run concurrently, each loading at least one common setup data field from data store 130).

Thus, changes to different stored instances of the same setup data may be synchronized. By doing so, it is possible to capture changes made to setup data by applications that load that data concurrently from the data store 130, whether the applications are two different instances of a single software application (e.g., two instances of a calendar that are being run concurrently, each having at least one common setup data field loaded from within data store 130) or multiple different software applications (e.g., two different browsers being run concurrently, each loading at least one common setup data field from data store 130).

For instance, the existence of a change in the local setup data may be identified through a comparison of the stored hash with a new hash of the local setup data, and the existence of a change in the server setup data may be identified through a comparison of the stored hash with a new hash of the server setup data. When the local setup data has not changed, synchronization and uploading are unnecessary and may be avoided altogether. When only the local setup data has changed, synchronization may not be necessary since no conflict exists. Nevertheless, to conserve bandwidth and increase performance, the changes may be identified and uploaded. When both change, however, synchronization may be performed to ensure that the most appropriate changes are communicated, where necessary, and maintained by the data store 730.

Specifically, even if the setup data stored at the destination application 710 and the data store 730 both have changed, it may be possible that the changes at each impact different aspects of the setup data. Therefore, the changes to each are identified and a comparison is performed to determine whether setup changes at each conflict. Where conflicts are determined not to exist, the changes from the local system may be uploaded without further processing. However, where conflicts are identified, they are resolved based on predefined logic (e.g., maintaining server data, comparing dates and replacing older with newer, maintaining local machine data) or based on user inquiry.

Ultimately, the modifications are passed to the server plug-in 722 to change the data in the data store 730 (step 760). In one implementation, an ACAP plug-in is used to modify the data stored by an ACAP server.

Moreover, by accessing the temporary data store 728, the synchronization engine 724 reads the dormant application setup data previously supplanted (step 770). This dormant setup data then is passed to the application-specific plug-in for conversion. Specifically, the application-specific plug-in 722 generally is responsible for converting application setup data and/or application end-purpose data retrieved from storage (728 and 730) into the application-specific format appropriate for the destination application (step 780). For example, the Microsoft Outlook application would require conversion of calendar data from the generic data format to Microsoft Outlook's specific calendar data format.

After the application-specific plug-in 722 has converted and passed the application setup data and/or application end-purpose data to the destination application 710 for storage (step 790), the destination application has been effectively returned to its original state. However, inasmuch as the data maintained by data store 728 is accessed and changed based on interactions with other instances of this and other applications, the changed version of the data will be loaded into the destination application 710 such that the application will differ from its original state.

Shortcuts to Setup Data for a Particular Identities

Shortcuts to application setup data may be saved to the desktop, such that each launches a different setup configuration or identity for a particular application or a collection of applications. For instance, a desktop shortcut may be created for each of two or more identities and used to access and load configuration settings for various applications according to the setup data stored for the accessed shortcut, as described with respect to FIGS. 6A and 6B. By invoking the desktop shortcut for one of the identities, one or more applications on or accessible to the computer may be configured with application setup data peculiar to that identity. Similarly, by invoking the desktop shortcut for another identity, one or more applications on or accessible to the computer may be configured with application setup data peculiar to that identity. Thereafter, by accessing another shortcut corresponding to setup data ordinarily maintained by the application or by otherwise indicating that the original settings are desired (e.g., again selecting the same shortcut), the supplanted and dormant settings data will be reinstated as described with respect to FIGS. 7A and 7B. As such, a device with a single-user platform may display multiple shortcuts to a single application, each corresponding to a different identity or configuration to enable the desktop and referenced application to operate as multiple-user device and application, respectively.

Application to Single-Identity Applications and Operating Systems

The foregoing may be applied to enable operating systems and applications designed for use by a single entity to be used by multiple identities. In fact, these concepts may be used to enable multiple identities in a single-user application (e.g., an application not specially designed for multiple identities/users) on the application level, without requiring that single-user application to be operated on a multi-user platform (e.g., Windows NT). For instance, a desktop or device with a single-user platform may display multiple shortcuts to a single application, each corresponding to a different identity or configuration to enable the desktop and referenced application to operate as multiple-user device and application, respectively.

Web Café Model (Shared Machines)

This technology also may be applied to enable a secure web café. For instance, with this technology, users are able to download and apply different configuration settings to one or more applications performed by a local machine without requiring the applications/machine to be reloaded/rebooted or former users to be logged out (e.g., by using icons dedicated to the setup data of different users).

More specifically, applications and machines ordinarily load setup data during a startup procedure. Therefore, to change the setup data of an application from user-to-user, it is generally necessary to reload the application by exiting the application, making the new setup data available to the application, and restarting the application. This process introduces obvious constraints for users in terms of time and convenience. Furthermore, the computer is taxed through the additional processing required to undergo the reloading of the application.

Recently, the concept of a web café has been realized. This concept involves a computer that is made accessible to several users. Presumably, each user has preferred configuration settings for one or more applications to be run on the computer. However, as described above, if a desired application is already running on the computer, a new user may either accept the current configuration settings loaded into that application, manually adjust the configuration settings to achieve preferred settings, or undergo a tedious and time-consuming process of reloading the application to achieve their own preprogrammed settings.

To provide users the ability to load new configuration settings into a currently running application without reloading that application, it is necessary to change the parameters referenced by the application during its operation. Applying the principles described above, this may be accomplished by supplanting the incumbent setup data referenced by an active application with desired configuration settings.

In one implementation, an application may be natively programmed to update its setup data with setup data stored at a predetermined location during operation. Then, the data stored at the predetermined location may be supplanted as described, to effect a change in configuration without requiring a reload. For instance, a shortcut on the computer desktop may be used to route the application to new setup data (e.g., different configuration or identity setup data), thus changing the configuration settings for that application without requiring the application to be reloaded. The new setup data may be loaded in response to user input (e.g., actuation of the shortcut button described above), in response to some other event, or at a scheduled time or periodic time interval.

The concepts implicated by this web café model also are applicable to other shared device situations. For example, the concepts may be applied to home-computing or hotel environments, where one or more family members or patrons may wish to preserve and access customized setup data on a single device without disturbing or accessing the device's default setup data or setup data customized by other family members or patrons who access that device.

In another example, these concepts may be applied to enable computing devices to be pooled. For example, where a number of users exceed the number of shared devices (e.g., 1000 users of 100 devices), these concepts may be used to enable the setup data appropriate for a particular accessing device to be loaded onto that device.

Furthermore, within a network, these concepts may be used to enable an end-user convenient access to network resources from any of several different devices. The user may move device-to-device within the network, downloading network configuration setup data to enable access to personalized information and resources on the current device without compromising the settings previously stored by that device. In this manner, the user need not download an entire Windows NT or other roaming profile, but may instead download settings applicable to the applications or services desired—saving valuable time and bandwidth.

Peer-to-Peer Paradigm

Where the storage of the generic application setup data is local to the application, a peer-to-peer paradigm may be achieved through the use of server software operating at the local machine. For instance, if server software were running on the local machine, other remote machines could contact the local machine to download setup data that is relevant to applications operating thereon. In this way, end-user machines communicate directly in a peer-to-peer configuration.

Devices Having Limited Storage Capacity

As mentioned, these processes may be applied to portable devices and devices with limited storage capacity (e.g., Palm and mobile communicator computing devices), as the dormant application setup data from one of these devices may be supplanted with setup data for any one of several users that may be maintained remotely while in a dormant state.

Similarly, these processes may be applied to devices with limited bandwidth, as the data communications may be performed intelligently based on an identification of applications for which remote data access is desired and/or necessary. That is, rather than a non-intelligent communication of all downloadable configuration information in response to a user registration or access/login procedure, incumbent setup data may be supplanted with desired downloaded for particular applications. The hierarchical data structure 400 may be used to enhance the intelligence of downloads, as relevant data is distinguishable and easily parseable from irrelevant data. From the user perspective, this enhances flexibility and preserves bandwidth. From the provider prospective, this decreases the tax on hardware and preserves bandwidth.

Multiple Device Configurations

The concepts described above may be applied to enable configuration of selected applications on more than one computer in response to one or more inputs. For instance, a network administrator may effect changes in the application setup data for applications on more than one different machine in their network. The changes may occur simultaneously on one or more of the machines. The changes may include loading a single application setup data parameter or profile into multiple devices, loading several application setup data parameters or profiles into multiple devices, or loading several application setup data parameters or profiles into a single machine. As the request is initiated by a third party to at least one of the machines, it may be sent by the requester to the synchronization core (e.g., 530), or it may be sent by the requestor to the target computers (e.g., a network administrator communicates request to end users machines on network) which themselves initiate a request for appropriate application setup data based on the information received from the requestor. In this example, a network administrator was referenced as the third party requestor; however, other third parties also could submit requests for multiple device configurations. In fact, the third party requestor may request changes to its own application setup data while requesting changes to application setup data for applications on other machines.

In one implementation of these concepts, a request may be made to change the application setup data on several machines that are interconnected through a network. In response to this request, the incumbent setup data for the subject application (e.g., Microsoft Outlook) on each machine is preserved and supplanted with stored application setup data, as described. This process may occur on each machine simultaneously, or otherwise (e.g., serial progression through specified machines). Furthermore, if more than one application is selected for reconfiguration, the preservation and supplantation processes may be performed with respect to each selected application on the several machines.

In another implementation, a new machine or several new machines may be initially configured based on default configuration settings. Specifically, based on an identification of software applications and/or machines to be configured, the above concepts may be applied to supplant incumbent setup data with stored default application setup data, effectively initializing new machines or reconfiguring existing/used machines. Thus, when application setup data becomes corrupted or undesirably changed, it may be easily reset to a default/template/desired state. This finds particular utility when an end user has a machine with applications that are not configured with desired application setup data, when an end user has a machine with a deficient, inaccurate or disfavored application setup data, or when global changes are desired for the application setup data of more than one user's machine, as a remote network administrator may effect simultaneous and/or automated changes remotely by submitting one or more requests.

Moreover, these concepts enable a trusted third party accessor (e.g., a system administrator) to remotely configure, reconfigure, alter, repair and generally maintain the application setup data of a machine or machines. In addition, these concepts may be applied to enable upgrades to be delivered from or loaded by a system administrator to multiple networked machines. For instance, where a device and/or software are upgraded, it may be necessary to load configuration setup data. In large networks, many devices or applications may be upgraded/replaced/changed simultaneously (e.g., periodically). Rather than requiring users to reconfigure the applications on their upgraded devices, the setup data for one or more applications may be supplanted with setup data appropriate to the user. Furthermore, rather than requiring the system administrator to perform the upgrade or load software applications device-by-device, the concepts described may be used to allow the system administrator to load setup data to each of several machines in response to a single request, and may allow for simultaneous loading, where appropriate. Conversely, where user devices and applications are neither replaced nor upgraded, but network changes cause a need for changing setup data for one or more applications (e.g., a new network server drive is added requiring changes to the operating systems of individual network devices to enable access to the added drive), these concepts may provide a means for delivery of changes to network devices in a relatively easy manner.

Devices Using Applications Performed by Application Service Providers (ASPs)

This technology can be used to store configuration setup data stored for applications running remote to the user, e.g., at an application service provider (ASP). Similarly, the technology can be used to store configuration setup data for applications whose configuration setup data is stored on servers (e.g., the NT domain server). Thus, in a corporate environment, this technology could operate transparent to the user, nevertheless enabling that user access to their setup data when operating an application from a location outside the corporate network.

The above technology may operate in conjunction with off-the-shelf source and destination applications and standard operating systems (OS), without special configuration of those applications or that operating system. Consequently, this technology may be used to configure new devices and/or applications quickly and effortlessly with the application setup data for one or more users.

General Implementation Details

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

Furthermore, various modifications to and applications of this technology may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A storage system, comprising:
first storage structure configured and arranged to store first application setup data derived from one or more software applications; and
second storage structure configured and arranged to store second application setup data obtained based on application setup data that are related by a second software application and that have been supplanted with one or more of the first application setup data.

2. The storage system of claim 1, wherein the first software application and the second software application are distinct instances of a single software application.

3. The storage system of claim 1, wherein the first software application and the second software application are different applications.

4. The storage system of claim 1, wherein the first storage structure and the second storage structure are both accessible to a single computer.

5. The storage system of claim 1, wherein the first storage structure is accessible to and the first software application is operable by a first computer system, and the second storage structure is accessible to and the second software application is operable by a destination application system that is distinct from the first computer system.

6. The storage system of claim 1, wherein the second storage structure is storage on a server, and the second application setup data is stored on the server as a result of the second application setup data being supplanted by the first application setup data.

7. A storage system of claim 1, further comprising a structure configured and arranged to store an affiliation between the first application setup data and an identity for which the first application setup data is applied to supplant the second application setup data.

8. The storage system of claim 1, wherein the second application setup data is stored in the second storage structure before the application setup data is used to supplant the second application setup data.

9. The storage system of claim 1, comprising a structure configured and arranged to store an association between the second application setup data and the first application setup data.

10. The storage system of claim 1, wherein the first and second application setup data include user-customized application setup data.

11. The storage system of claim 1, wherein the first and second application setup data consist of user-customized application setup data.

12. The storage system of claim 1, wherein the second application setup data stored in the second storage structure includes a copy of application setup data from the destination application.

13. The storage system of claim 1, wherein contents of the first and second storage structure are changed when the software application performed by the destination application no longer requires use of the first application setup data, as an updated version of the first application setup data is copied from the destination application to the first storage structure before the first application setup data on the destination application is replaced with the second application setup data from the second storage structure.

14. The storage system of claim 13, wherein the updated version of the first application setup data includes application setup that are customized by the user based on user preferences identified during performance of the software application by the destination application.

15. The storage system of claim 1, wherein the second application setup data stored in the second storage structure is obtained based on user-customized application setup data for the software application when the software application on the destination application that has been customized by a user.

16. The storage system of claim 1, wherein the second application setup data stored in the second storage structure is derived from default application setup data for the software application when the software application on the destination application has not been customized by a user.

17. The storage system of claim 1, wherein the second application setup data stored in the second storage structure includes application setup data for multiple software applications on which application setup data has been supplanted.

18. The storage system of claim 1, wherein the first application setup data stored in the first storage structure and second application setup stored in the second storage structure for a single configuration setting data differ in format.

19. The storage system of claim 1, wherein the first application setup data stored in the first storage structure includes several sets of application setup data for a single application, at least one of which being downloaded to the application-driving destination application.

20. The storage system of claim 1, wherein the destination application is run on a portable device that has limited storage capacity.

21. The storage system of claim 20, wherein the portable device is a cellular telephone.

22. The storage system of claim 20, wherein the portable device is a handheld device.

23. A storage system, comprising:
first storage means for storing first application setup data derived from one or more software applications; and
second storage means for storing second application setup data obtained based on application setup data that are related by a second software application and that have been supplanted with one or more of the first application setup data.

24. The storage system of claim 23, wherein the first software application and the second software application are distinct instances of a single software application.

25. The storage system of claim 23, wherein the first software application and the second software application are different applications.

26. The storage system of claim 23, wherein the first storage means and the second storage means are both accessible to a single computer.

27. The storage system of claim 23, wherein the first storage means is accessible to and the first software application is operable by a first computer system, and the second storage means is accessible to and the second software application is operable by a destination application system that is distinct from the first computer system.

28. The storage system of claim 23, wherein the second storage means is storage on a server means, and the second application setup data is stored on the server means as a result of the second application setup data being supplanted by the first application setup data.

29. A storage system of claim 23, further comprising means for storing an affiliation between the first application setup data and an identity for which the first application setup data is applied to supplant the second application setup data.

30. The storage system of claim 23, wherein the second application setup data is stored in the second storage means before the application setup data is used to supplant the second application setup data.

31. The storage system of claim 23, comprising means for storing an association between the second application setup data and the first application setup data.

32. The storage system of claim 23, wherein the first and second application setup data include user-customized application setup data.

33. The storage system of claim 23, wherein the first and second application setup data consist of user-customized application setup data.

34. The storage system of claim 23, wherein the second application setup data stored in the second storage means includes a copy of application setup data from the destination application.

35. The storage system of claim 23, wherein contents of the first and second storage means are changed when the software application performed by the destination application no longer requires use of the first application setup data, as an updated version of the first application setup data is copied from the destination application to the first storage means before the first application setup data on the destination application is replaced with the second application setup data from the second storage means.

36. The storage system of claim 35, wherein the updated version of the first application setup data includes application setup that are customized by the user based on user preferences identified during performance of the software application by the destination application.

37. The storage system of claim 23, wherein the second application setup data stored in the second storage means is obtained based on user-customized application setup data for the software application when the software application on the destination application that has been customized by a user.

38. The storage system of claim 23, wherein the second application setup data stored in the second storage means is derived from default application setup data for the software application when the software application on the destination application has not been customized by a user.

39. The storage system of claim 23, wherein the second application setup data stored in the second storage means includes application setup data for multiple software applications on which application setup data has been supplanted.

40. The storage system of claim 23, wherein the first application setup data stored in the first storage means and second application setup stored in the second storage means for a single configuration setting data differ in format.

41. The storage system of claim 23, wherein the first application setup data stored in the first storage means includes several sets of application setup data for a single application, at least one of which being downloaded to the application-driving destination application.

42. The storage system of claim 23, wherein the destination application is run on a portable device that has limited storage capacity.

43. The storage system of claim 42, wherein the portable device is a cellular telephone.

44. The storage system of claim 42, wherein the portable device is a handheld device.
